(19) United States
(12) Patent Application Publication
(10) Pub. No.: US 2006/0110574 A1
(43) Pub. Date: May 25, 2006

(54) Interleaved disposable tablecloth roll

(76) Inventor: David Freier, Brooklyn, NY (US)

Correspondence Address: Esther E. Schwartz, 1898 Ocean Avenue, Brooklyn, NY, 11230, US

(21) Appl. No.: 10/994,967

(22) Filed: Nov. 22, 2004

(51) Int. Cl. B32B 3/04

(52) U.S. Cl. 428/121; 428/43

(57) ABSTRACT

I have invented an interleaved disposable tablecloth roll. Successive longitudinally folded pre-cut tablecloth sheets are provided on a coreless roll. The last five inches of each tablecloth are overlapped with the first five inches of the successive tablecloth so that the rear edge of each tablecloth is above the leading edge of the successive tablecloth.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A “SEQUENCE LISTING,” A TABLE, OR A COMPUTER PROGRAM LISTING APPENDIX SUBMITTED ON A COMPACT DISC

Not Applicable

### BACKGROUND OF THE INVENTION

(1) Field of the Invention

This invention relates to packaging disposable tablecloths. More particularly, this invention relates to interleaved disposable tablecloths.

(2) Description of the Related Art Including Information Disclosed Under 37 CFR 1.97 and 1.98.

Disposable Tablecloths are well known in the prior art. Disposable Tablecloths are usually made of plastic or paper and provide increased convenience and enhanced sanitary features. Disposable Tablecloths have become a virtual staple.

While disposable tablecloths provide many excellent features, there are several problems that persist pertaining to storing and dispensing individual tablecloths in personal or commercial settings.

Pre-cut disposable tablecloths are available, but are packaged in small quantities. Large quantities are usually only available on rolls of perforated sheets. For constant use or bulk use, stacked pre-cut disposable tablecloths present several disadvantages. The stacks are difficult to store and the plastics slip against each other. They are also difficult to dispense one at a time.

Rolls of perforated disposable tablecloths present other problems. When used in commercial settings, time is wasted separating the sheets. In addition, the edges of the tablecloths are not as neat and presentable as pre-cut tablecloths. In home use, perforated tablecloths present additional problems. Many religious Jews use disposable tablecloths for Sabbath and Holiday meals for convenience. Because of the prohibition of tearing, ripping, or cutting on Sabbath or Holidays, the perforated tablecloths must be separated prior to Sabbath or Holidays. This adds an inconvenience to a product intended to enhance convenience. It is difficult to store the pre-ripped tablecloths, and difficult to remember to separate them in advance of one's need.

There is a need for an improved method of storing and dispensing disposable tablecloths that eliminates all the disadvantages present in the prior art.

My invention solves all the problems in the existing art with an interleaved disposable tablecloth roll.

There are several references in the prior art that provide varied interleaved products on a roll. For example, U.S. Pat. No. 1,767,860 discloses a roll of interleaved sheets in which successive sheets are folded about each other in a unique configuration for ease in dispensing. U.S. Pat. No. 3,826,361 discloses a plastic bag dispensing system in which folded plastic bags ore overlapped, rolled into a cylindrical roll, and placed in a package with an opening for dispensing. U.S. Pat. No. 5,609,269 discloses a roll of interleaved and overlapped tissues for pop-up dispensing purposes. U.S. Pat. No. 6,431,396 B1 discloses interleaved roll mounted bags and dispensers for same.

However, no product exists in the current art that provides an interleaved roll of disposable tablecloths.

It is therefore an object of the present invention to provide a more convenient means for storing and dispensing pre-cut disposable tablecloths.

It is a further object of the present invention to provide an interleaved roll of disposable tablecloths.

It is a further object of the present invention to provide folded disposable tablecloths arranged with a five inch overlap and wound into a roll.

### BRIEF SUMMARY OF THE INVENTION

I have invented an interleaved disposable tablecloth roll. Successive longitudinally folded pre-cut tablecloth sheets are provided on a coreless roll. The last five inches of each tablecloth are overlapped with the first five inches of the successive tablecloth so that the rear edge of each tablecloth is above the leading edge of the successive tablecloth.

### BRIEF DESCRIPTION OF THE SEVERAL VIEWS OF THE DRAWINGS

FIG. 1. is a front view of an unfolded disposable tablecloth.

FIG. 2. is a perspective view of the interleaved disposable tablecloth roll.

FIG. 3. is a front view of an alternate embodiment of the invention where the tablecloths are overlapped prior to folding.

### DETAILED DESCRIPTION OF THE INVENTION

The invention, as depicted in FIGS. 1-3, generally comprises a means of storing and dispensing a multitude of tablecloths 10 of a flexible material such as plastic, preferably disposable and resilient, where the pre-cut tablecloths 10 are provided on an interleaved coreless roll.

FIG. 1 is a front view of a single disposable tablecloth 10 that has been dispensed from the roll and unfolded. Each disposable tablecloth 10 has a first end 20 and a second end 25. The tablecloths are preferably folded in half longitudinally along the fold-line 15 to provide a more compact roll. The double thickness of the folded tablecloth is also easier to grasp and thus easier to dispense.

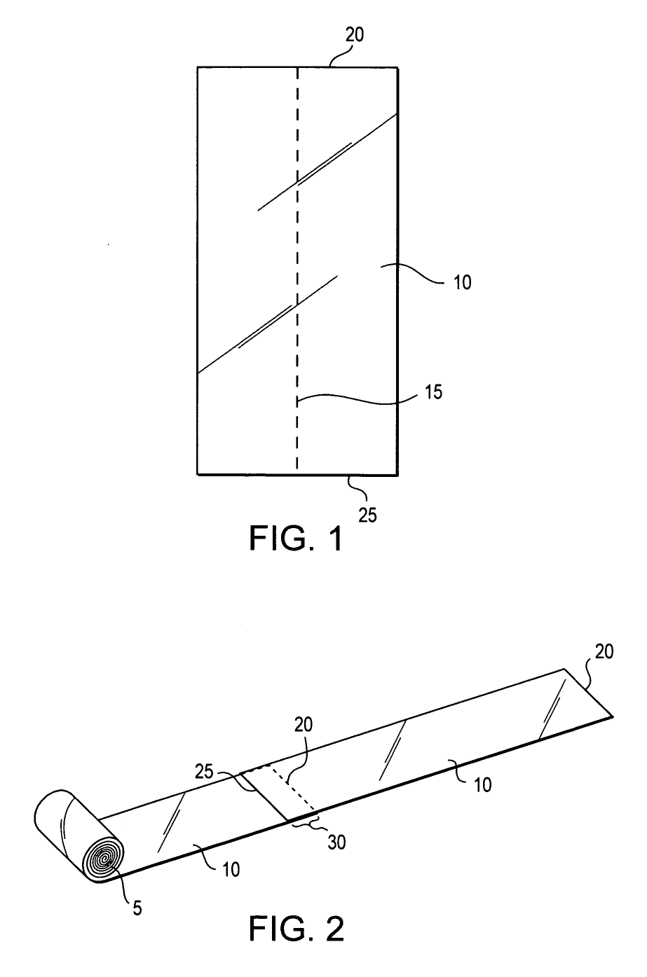

FIG. 2. is a perspective view of the coreless roll 5, depicting the overlapped portion 30 of each successive disposable tablecloth 10. The overlapped portion 30 is formed by placing the second end 25 of each disposable tablecloth 10 over the first end 20 of the next disposable tablecloth 10 with a resulting overlapped portion 30 of five inches. The folded and overlapped tablecloths are then wound into a coreless roll where the first end 20 of the outermost tablecloth is available for dispensing.

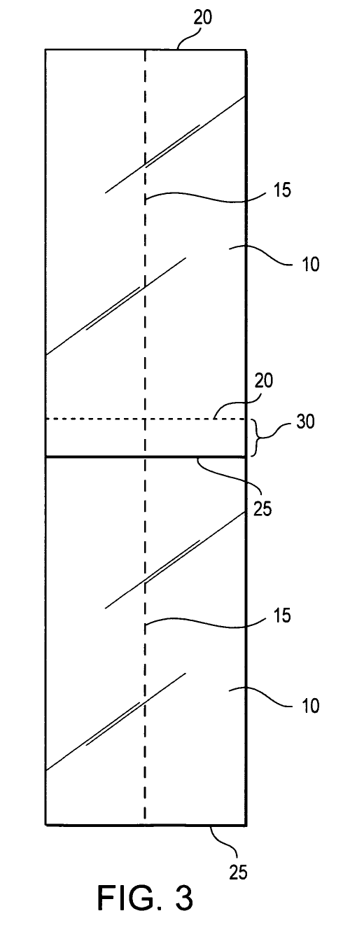

FIG. 3. is a front view of an alternate embodiment of the invention. In this alternate configuration, the first end 20 of the disposable tablecloth 10 is overlapped with the second end 25 of the disposable tablecloth 10, forming the overlapped portion 30, prior to folding the tablecloths along the fold-line 15. The overlapped and folded disposable tablecloths are then wound into a coreless roll.

In the preferred embodiment the leading disposable tablecloth 10 overlaps the succeeding disposable tablecloth 10 so that the second end 25 of each tablecloth is above the first end 20 of the successive tablecloth. However, the leading disposable tablecloth 10 can also be overlapped by the succeeding disposable tablecloth 10 so that the second end 25 of each tablecloth is below the first end 20 of the successive tablecloth.

In the alternate embodiment, the disposable tablecloths 10 are overlapped and then folded instead of folded and then overlapped. Preferably, the disposable tablecloths 10 are overlapped so that the second end 25 is above the first end 20 of the successive disposable tablecloth 10. When folded, the successive disposable tablecloth will be wrapped around the leading disposable tablecloth for the overlapped portion 30.

The tablecloths arranged in the alternate embodiment can also be overlapped so that the second end 25 is below the first end 20 of the successive disposable tablecloth 10. When folded, the leading tablecloth will be wrapped around the successive tablecloth for the overlapped portion 30.

In the preferred embodiment, there is a five inch overlap. However, the overlapped portion can be shorter or longer to accommodate various sizes and textures of tablecloths.

The tablecloths can be of any size or shape to suit the needs of the end user. The tablecloths can be overlapped and rolled in their unfolded state as well. The tablecloths can also be folded in half along a horizontal axis, a vertical axis, or both. In addition, the tablecloths can be folded into thirds, or any other practical configuration. The tablecloths can be folded before or after being overlapped, and can also be folded both before and after being overlapped.

The tablecloths are preferably formed of a disposable flexible plastic of suitable thickness. However, the tablecloths can be formed of any effective, appropriate material, including but not limited to paper or paper and plastic combinations. The tablecloths can be formed of plastic backed paper. The tablecloths can be padded. The tablecloths can have a trim around the perimeter.

The tablecloths can also be provided in single colors, or color combinations. The tablecloths can contain designs, images, or licensed graphics.

The tablecloths can be formed in rolls of any suitable thickness containing any suitable amount of tablecloths on any one roll. The tablecloths are preferably rolled into a coreless roll, but can be overlapped and rolled around a core as well.

We have illustrated a preferred embodiment of the invention. However, it is to be understood that changes and variations may be made by those skilled in the art without departing from the spirit of the invention as claimed.

Many variations of the invention will occur to those skilled in the art. All such variations are intended to be within the scope and spirit of the invention. Although some embodiments are shown to include certain features, we specifically contemplate that any feature disclosed in this description may be used together or in combination with any other feature on any embodiment of the invention. We have also contemplated that any feature may be specifically excluded from any embodiment of an invention.

Further aspects of the invention will become apparent from consideration of the drawings and the description of preferred embodiments of the invention. A person skilled in the art will realize that other embodiments of the invention are possible and that the details of the invention can be modified in a number of respects, all without departing from the inventive concept. Thus, the drawings and description are to be regarded as illustrative in nature and not restrictive.

### LIST OF REFERENCE NUMBERS

5. Coreless Roll

10. Disposable Tablecloth

15. Fold-line

20. First End

25. Second End

30. Overlapped Portion

1. A Roll of Tablecloths comprising:
a. A plurality of tablecloths;
b. each of said tablecloths having first and second parallel side edges, a leading edge and a rear edge;
c. said tablecloths being folded;
d. said folded tablecloths being overlapped upon each other so that a portion of the rear edge of each of said tablecloths rests upon a portion of the leading edge of a subsequent tablecloth;
e. said overlapped tablecloths being rolled to form a compact roll from which the tablecloths are dispensed one at a time.

2. The roll of tablecloths of claim 1 in which said tablecloths are disposable.

3. The roll of tablecloths of claim 1 in which said tablecloths are plastic.

4. The roll of tablecloths of claim 1 in which said tablecloths are folded along a vertical axis between the first and second parallel side edges before being overlapped.

5. The roll of tablecloths of claim 1 in which said tablecloths are folded along a first vertical axis between the first and second parallel side edges, and then folded again along a second vertical axis between the first vertical axis and the first and second parallel side edges before being overlapped.

6. The roll of tablecloths of claim 1 in which said tablecloths are folded along a vertical axis between the first and second parallel side edges, and folded along a horizontal axis between said leading edge and said rear edge before being overlapped.

7. The roll of tablecloths of claim 1 in which said overlapped portion is five inches long.

8. The roll of tablecloths of claim 1 in which said tablecloths are formed of at least one layer of a disposable material.

9. The roll of tablecloths of claim 1 in which said tablecloths are formed of plastic backed paper.

10. The roll of tablecloths of claim 1 in which said tablecloths are rolled into a coreless roll.

11. The roll of tablecloths of claim 1 in which said tablecloths are rolled around a core.

12. The roll of tablecloths of claim 1 in which said tablecloths are overlapped upon each other so that a portion of the leading edge of each of said tablecloths rests upon a portion of the rear edge of a subsequent tablecloth;

13. The roll of tablecloths of claim 1 in which said overlapped portion is between four and six inches long.

14. The roll of tablecloths of claim 1 in which said tablecloths are formed of paper.

15. The roll of tablecloths of claim 1 in which said tablecloths are decorated.

16. A Roll of Tablecloths comprising:
a. A plurality of tablecloths;
b. each of said tablecloths having first and second parallel side edges, a leading edge and a rear edge;
c. said tablecloths being overlapped upon each other so that a portion of the rear edge of each of said tablecloths rests upon a portion of the leading edge of a subsequent tablecloth;
d. said overlapped tablecloths being folded along a vertical axis between the first and second parallel side edges;
e. said overlapped and folded tablecloths being rolled to form a compact roll from which the tablecloths are dispensed one at a time.

17. The roll of tablecloths of claim 16 in which said tablecloths are folded before and after being overlapped.

18. A Roll of Tablecloths comprising:
a. A plurality of tablecloths;
b. each of said tablecloths having first and second parallel side edges, a leading edge and a rear edge;
c. said tablecloths being overlapped upon each other so that a portion of the rear edge of each of said tablecloths rests upon a portion of the leading edge of a subsequent tablecloth;
d. said overlapped tablecloths being rolled to form a compact roll from which the tablecloths are dispensed one at a time.

19. The roll of tablecloths of claim 18 in which the tablecloths are folded.

20. The roll of tablecloths of claim 18 in which said tablecloths are overlapped upon each other so that a portion of the leading edge of each of said tablecloths rests upon a portion of the rear edge of a subsequent tablecloth.
